(19) United States
(12) Patent Application Publication
(10) Pub. No.: US 2026/0063126 A1
(43) Pub. Date: Mar. 5, 2026

(54) Polymer Rotary Feeder Vanes

(71) Applicant: Chevron Phillips Chemical Company LP, The Woodlands, TX (US)

(72) Inventors: Daniel S. Vause, Baytown, TX (US); Jeffrey S. Lowell, Kingwood, TX (US); Stefan M. Brady, Baytown, TX (US)

(21) Appl. No.: 18/821,436

(22) Filed: Aug. 30, 2024

(51) Int. Cl. F04D 7/00; B01J 4/00; B65G 65/48; F04D 29/18; F04D 29/40

(52) U.S. Cl. CPC F04D 7/00; B01J 4/007; B65G 65/4881; F04D 29/18; F04D 29/40; B01J 2204/005; B65G 2201/042

(57) ABSTRACT

Disclosed are configurations, processes, and systems for utilizing a rotary feeder that has vanes with nonlinear edges, vanes with linear edges and with agglomerate pockets formed in the vanes, or vanes with nonlinear edges and with agglomerate pockets formed in the vanes.

### FIELD OF THE DISCLOSURE

The present disclosure relates to a rotary feeder for moving polymer product from one location to another.

### BACKGROUND

Polymer rotary feeders are used to transfer material (e.g., polymer) from one component to another in a polymer manufacturing process. Rotary feeders are designed to handle and transfer uniform size particles and often have difficulty transferring large or bulky agglomerates of polymer particles. Traditional rotary feeders utilize straight feeder vanes that are designed to maximize the capacity, and consequently the throughput, of the rotary feeder.

Any agglomerates that are larger than the cavities formed between adjacent vanes of the rotary feeder can become lodged in the inlet of the rotary feeder, between the rotary feeder housing and the rotary feeder vanes, thereby halting rotation of the rotary feeder vanes within the rotary feeder housing and causing the rotary feeder motor to trip to prevent damage to the feeder. The rotary feeder industry has continuously attempted to address this problem with heavier-duty rotary feeder components, such as stronger shafts, reinforced housings, and higher horsepower motors. However, existing rotary feeders cannot be upgraded to handle the higher torque needed to cut through these agglomerates.

Accordingly, the industry continues to demand technological improvements in rotary feeders that eliminate downtime caused by lodged agglomerates and that provide existing rotary feeders the capability of being upgraded.

### SUMMARY

A rotary feeder for a polymer product includes: a housing having an inner wall that defines a cavity, wherein the housing has an inlet fluidly connected to the cavity and an outlet fluidly connected to the cavity; a shaft disposed in the housing along a central axis of the cavity; and a rotor coupled to the shaft, wherein the shaft and the rotor rotate within cavity of the housing to move the polymer product from the inlet to the outlet, wherein the rotor includes a plurality of vanes arranged to: I) break, with at least one nonlinear edge of the plurality of vanes, an agglomerate of the polymer product into pieces that are smaller than the agglomerate, and move the pieces from the inlet to the outlet while the rotor rotates in the housing, ii) receive the agglomerate in an agglomerate pocket of the plurality of vanes, and move the agglomerate in the agglomerate pocket from the inlet to the outlet while the rotor rotates within the housing, or iii) break, with at least one nonlinear edge of the plurality of vanes, an agglomerate of the polymer product into pieces that are smaller than the agglomerate, receive the pieces in an agglomerate pocket or carrier spaces of the plurality of vanes, and move the pieces in the agglomerate pocket or the carrier spaces from the inlet to the outlet while the rotor rotates within the housing.

A process includes rotating a rotor in a housing of a polymer rotary feeder, wherein the rotor includes a plurality of vanes having an agglomerate pocket and carrier spaces; receiving an agglomerate of a polymer product into the agglomerate pocket; receiving polymer fluff into the carrier spaces; and moving the agglomerate in the agglomerate pocket and the polymer fluff from an inlet of the housing to an outlet of the housing.

Another process includes rotating a rotor in a housing of a polymer rotary feeder, wherein the rotor includes a plurality of vanes having at least one nonlinear edge; breaking an agglomerate of a polymer product into pieces that are smaller than the agglomerate with the at least one nonlinear edge; and moving the pieces in the plurality of vanes from an inlet of the housing to an outlet of the housing.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is a cross-sectional side view of a rotary feeder according to an embodiment of the disclosure.

FIGS. 2A to 2E are partial oblique views of rotary feeder vane configurations according to embodiments of the disclosure.

FIGS. 3A to 3F are partial oblique views of various rotary feeder vane configurations according to embodiments of the disclosure.

FIG. 4 is a schematic diagram of a polymer processing system according to an embodiment of the disclosure.

The use of the same reference symbols in different drawings indicates similar or identical items.

### DETAILED DESCRIPTION

“Polymer product” as disclosed herein refers to the solid product recovered into a purge column or hopper from a polymer manufacturing process. For example, a polymer product can be the solid product recovered from a reactor effluent produced by the catalyzed polymerization of one or more olefins in a polymerization reactor, such as the catalyzed polymerization of ethylene or propylene in a loop slurry reactor, gas phase reactor, an autoclave reactor, or combinations thereof, to produce polyethylene or polypropylene according to techniques known in the art. The reactor effluent can flow from the polymerization reactor to a product separator (e.g., a flash tank) where gases and some liquids evaporate and are separated from the solid product to form the polymer product discussed herein. The polymer product can be introduced into the purge column and then from the purge column to the hopper. Alternatively, the polymer product can be introduced to the hopper without passing through the purge column. The polymer product then flows from the hopper to the rotary feeder disclosed herein.

During product recovery in a polymerization process, some of the polymer product (e.g., polymer particles that can also be referred to as polymer fluff) can bind together to form larger polymer chunks, referred to herein as agglomerates. Agglomerates are commonly formed as irregularly shaped solid objects that flow with the polymer fluff as part of the polymer product. These polymer agglomerates can range in size from having a dimension larger than a single polymer fluff particle to having a dimension of 10 centimeters or more. The larger polymer agglomerates can become lodged in the inlet of the rotary feeder (e.g., because they are too large to pass into the vane assembly), between the rotary feeder housing and the rotary feeder vanes (e.g., one dimension is small enough to fit between two adjacent vanes and another dimension of the agglomerate is large enough so that the agglomerate extends partially in the vane assembly and partially in the inlet of the rotary feeder), thereby causing blockage of flow and halting rotation of the rotary feeder vanes within the rotary feeder housing and causing the rotary feeder motor to trip to prevent damage to the feeder.

Disclosed are configurations, processes, and systems for utilizing a rotary feeder that has vanes with nonlinear edges, vanes with linear edges and with agglomerate pockets formed in the vanes, or vanes with nonlinear edges and with agglomerate pockets formed in the vanes. The configurations increase the efficiency of passing agglomerates through the rotary feeder and/or breaking agglomerates into smaller pieces or fragments that pass through the rotary feeder.

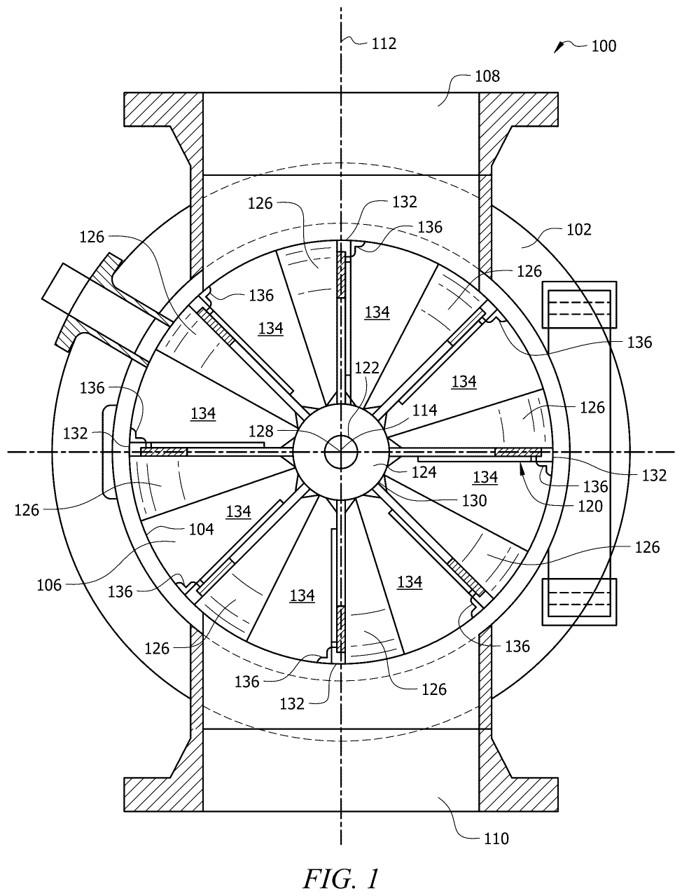

FIG. 1 shows a cross-sectional side view of a rotary feeder 100 according to an embodiment of the disclosure. The rotary feeder 100 may include a cylindrical housing 102 comprising an inner surface or wall 104 that defines a cylindrical-shaped cavity 106 within the rotary feeder 100. The housing 102 may also comprise an inlet 108 coupled in fluid communication or fluidly connected with the cavity 106 and an outlet 110 coupled in fluid communication or fluidly connected to the cavity 106. In some embodiments, the inlet 108 may be positioned at a top of the housing 102, and the outlet 110 may be positioned at a bottom of the housing 102. In some embodiments, the inlet 108 and the outlet 110 share the same central axis 112 (e.g., which can be a longitudinal axis). Further, a central axis 114 (e.g., which can be a longitudinal axis) of the cavity 106 may intersect and/or be substantially orthogonal to the central axis 112 of the inlet 108 and the outlet 110.

The rotary feeder 100 may also comprise a rotatable vane assembly 120 placed or otherwise disposed within the cylindrical housing 102. The rotatable vane assembly 120 may comprise a shaft 122, a rotor 124 (which can also be referred to as a hub) coupled to the shaft 122, and a plurality of rotary feeder vanes 126 coupled to the rotor 124. The shaft 122, the rotor 124, and the vanes 126 may collectively rotate within the housing 102 about a central axis 128 as a unitary component. In some embodiments, the central axis 128 (i.e., axis of rotation) of the vane assembly 120 is the same as the central axis 114 of the cavity 106. As such, the central axis 128 of the vane assembly 120 may intersect and/or be substantially orthogonal to the central axis 112 of the inlet 108 and the outlet 110. In some embodiments, the shaft 122, the rotor 124, and the vanes 126 may be manufactured as a unitary component. However, in some embodiments, any of the shaft 122, the rotor 124, and the vanes 126 may be manufactured as one or more separate components that are joined together by fasteners, splines, welding, and/or any other techniques or combination of techniques known in the art with the aid of this disclosure.

As stated, the rotor 124 may comprise a plurality of vanes 126 coupled thereto and disposed about an outer surface 130 of the rotor 124.

The vanes 126 generally have edges 132 that are “exposed” to or face the inlet 108 and the outlet 110 as the rotatable vane assembly 120 rotates in the housing 102. In aspects, the edges 132 may also be referred to as “exposed edges.” These edges 132, or “exposed edges,” are contrasted with the ends, sides, or edges of the vanes 126 that face the side walls of the housing 102 (e.g., the side walls that connect to the inner surface or wall 104 of the housing 102). The ends, sides, or edges of the vanes 126 that face the side walls of the housing 102 do not face the inlet 108 or the outlet 110 and thus are not defined herein as the edges 132 that are exposed to or face the inlet 108 and the outlet 110 of the housing 102 as the rotatable vane assembly 120 rotates in the housing 102. The ends, sides, or edges of the vanes 126 that face the side walls of the housing 102 can be referred to as “non-exposed edges,” “non-exposed sides,” or “non-exposed ends” because they do not face the inlet 108 or outlet 110 of the housing 102 as the rotatable vane assembly 120 rotates in the cavity 106 of the housing 102.

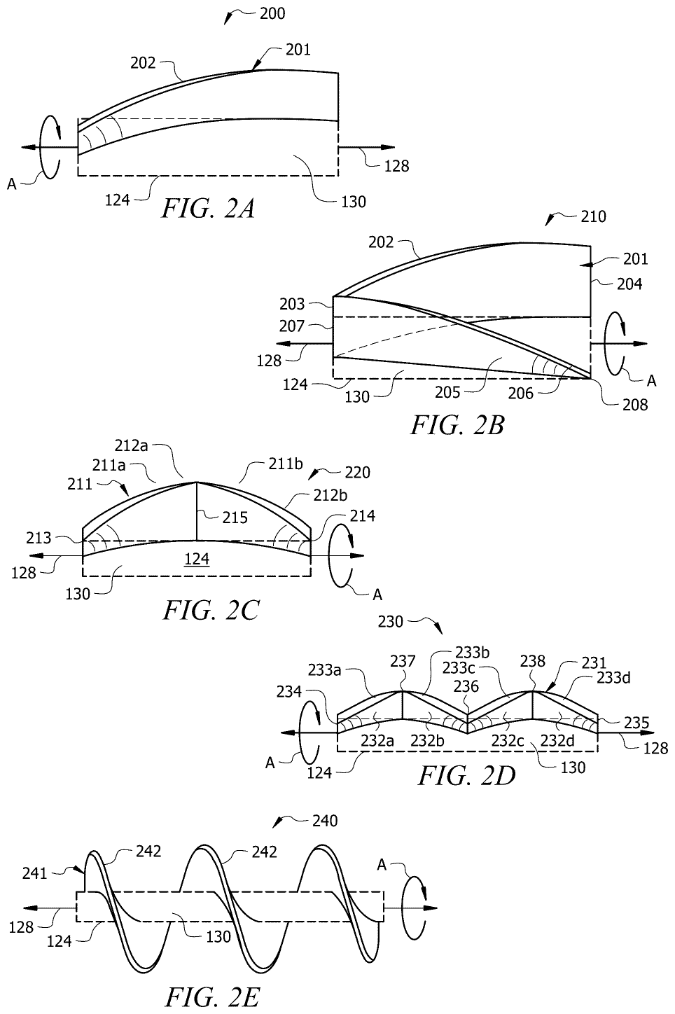

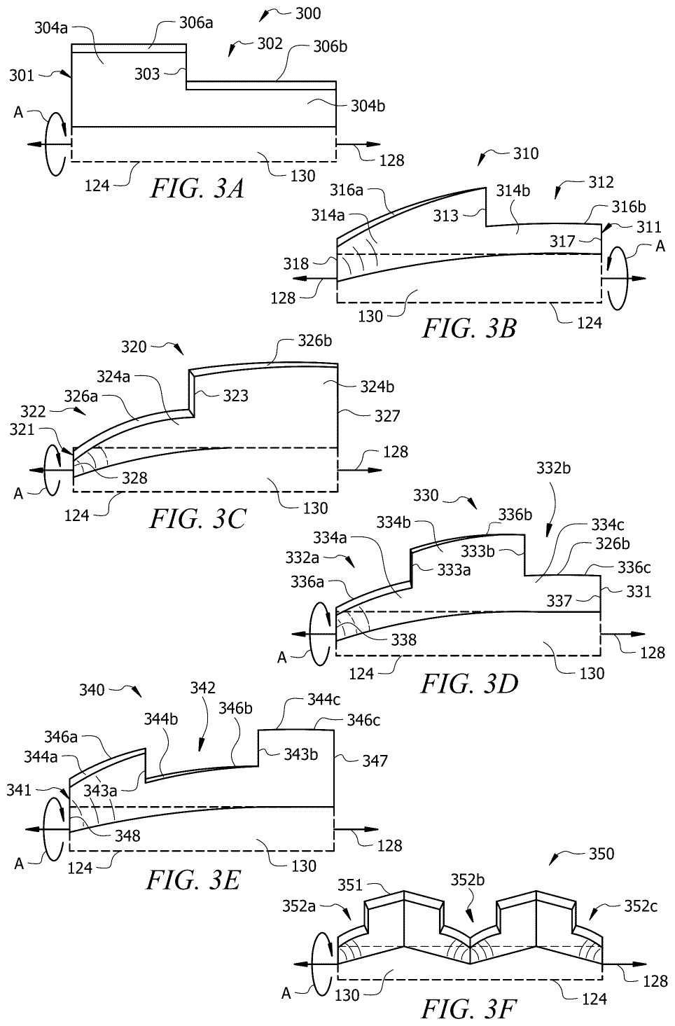

In some embodiments, the edges 132 of the vanes 126 may be disposed at an angle relative to the central axis 128, whereas traditional vane designs orient the edges 132 of the vanes parallel to the central axis 128. Said differently, in some embodiments, the entirety of each of the vane 126 is not radially aligned across the outer surface 130 of the rotor 124. As such, the vanes 126 may be defined as comprising edges 132 that are nonlinear (e.g., nonlinear edges). “Nonlinear edges” in this context may be defined as the edges 132 of the vanes 126 being not parallel to the central axis 128. The vanes 126 may consequently comprise an angled, helical, spiraled, curved, chevroned, V-shaped, W-shaped, or other profile across and/or around the outer surface 130 of the rotor 124 that is non-radially and/or non-longitudinally aligned with the central axis 128. Examples of vanes 126 having nonlinear edges, or nonlinear exposed edges, are illustrated in FIGS. 2A, 2B, 2C, 2D, 2E, 3B, 3C, 3D, 3E, and 3F.

In alternative embodiments, the edges 132 of the vanes 126 may be linear (disposed parallel to the central axis 128) and have one or more features (e.g., agglomerate pockets). In these embodiments, at least one of the vanes 126 has multiple portions, where a first portion of the vane 126 extends radially outwardly further than a second portion of the vane 126, forming a “pocket” of space between the second portion of the vane 126 and the inner surface or wall 104 of the housing 102. The pocket of space can receive agglomerates of the polymer, and the pocket of space can be referred to herein as an agglomerate pocket. Any number of the vanes 126 of the rotatable vane assembly 120 can having portions that form an agglomerate pocket. An example of this configuration is illustrated in FIG. 3A.

Further, in other alternative embodiments, the edges 132 of the vanes 126 may be disposed at an angle relative to the central axis 128 (e.g., nonlinear edges), such that the entirety of each vane 126 is not radially aligned across the outer surface 130 of the rotor 124, and also comprise one or more features (e.g., agglomerate pockets). Examples of this configuration are illustrated in FIGS. 3B, 3C, 3D, 3E, and 3F.

In some embodiments, one or more of the vanes 126 may converge across the rotor 124 such that a non-exposed end of one vane couples to or connects to a non-exposed end of another vane. Examples of this configuration is illustrated in FIG. 2B, FIG. 2D, FIG. 2D, and FIG. 3F.

In operation of the rotary feeder 100, a polymer product comprising polymer fluff, and in some case the polymer product can contain agglomerates of polymer fluff, may be received within the rotary feeder 100. More specifically, the polymer product may be received into carrier spaces 134 formed between adjacent vanes 126. To the extent agglomerates are contained in the polymer product, some embodiments contemplated that the edges 132 of the vanes 126 can break (e.g., chop, divide, slice, sever, or otherwise separate) the agglomerates into smaller, workable polymeric pieces or fragments move the smaller, workable polymeric pieces or fragments while the polymer product is rotated and moved by the rotatable vane assembly 120 from the inlet 108 to the outlet 110 while the rotatable vane assembly 120 rotates in the housing 102.

Vane configurations that utilize the nonlinear profile and/or nonlinear edges 132 of the vanes 126 may allow a more effective at breaking, chopping, dividing, slicing, severing, or otherwise separating the agglomerates into smaller, workable polymeric pieces or fragments that can easily pass into the rotatable vane assembly 120. Vane configurations that utilize pockets may be beneficial to receiving larger agglomerates that are not broken therein or receiving additional volume of pieces of agglomerates therein. In some embodiments, the pockets may provide at least a 5%, at least a 10%, at least a 15%, at least a 20%, or even at least a 25% greater volume in the carrier spaces 134 as compared to a rotatable vane assembly 120 that does not have pockets.

In some embodiments, one or more of the vanes 126 may have blades 136 attached on or near the edges 132 of the vane 126. In some embodiments, some of the vanes 126 have blades 136 and some of the vanes 126 do not have blades 136; alternatively, all the vanes 126 have blades 136; alternatively, none of the vanes 126 have blades 136. The blades 136 may be disposed along the edges 132 of the vanes 126. The blades 136 may also be disposed substantially adjacent to the inner surface or wall 104 of the cavity 106 of the housing 102. The blades 136 are configured to follow the contour of the edges 132 of the vanes 126. For example, for vanes 126 having edges 132 that are nonlinear and that also have blades 136, the blades 136 are also nonlinear and have the same nonlinear contour as the edges 132. For vanes having edges 132 that are linear and that also have blades 136, the blades 136 are also linear and have the same linear contour as the edges 132. The blades 136 may enhance breaking, chopping, dividing, slicing, severing, or otherwise separating the agglomerates in smaller, workable polymeric pieces or fragments that can easily pass into the rotatable vane assembly 120 as the agglomerates enter the cavity 106 of the housing 102 and/or carrier spaces 134 of the rotatable vane assembly 120, which may enhance the breaking of the agglomerates into smaller, workable polymeric pieces or fragments and/or reduce the overall torque requirements of the rotary feeder 100 as compared to vanes that do not have blades 136.

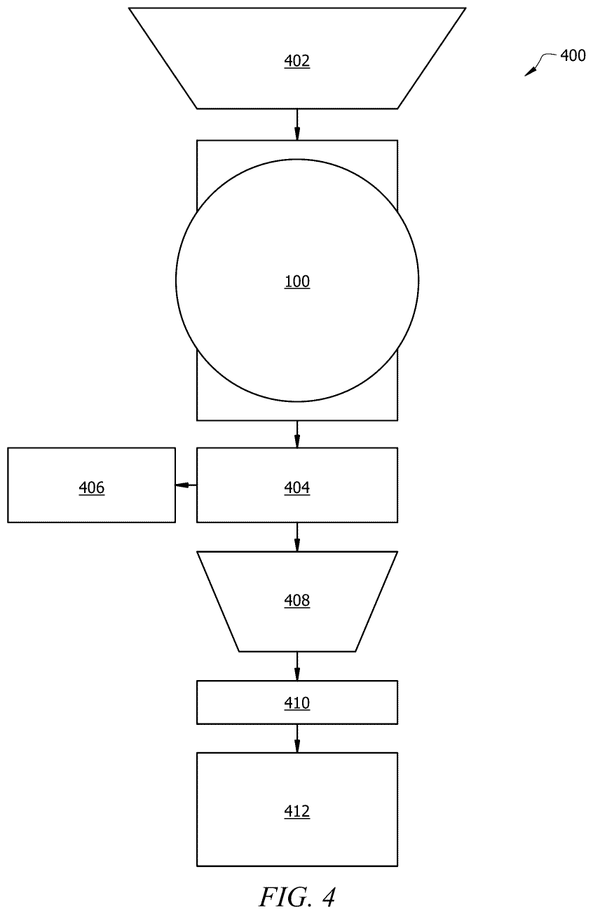

Utilizing a plurality of vanes 126 may maintain a pressure differential through the rotary feeder 100 and between equipment (e.g., a purge column or hopper 402, see FIG. 4) coupled to the inlet 108 of the rotary feeder 100 and equipment (e.g., a classifier 404, see FIG. 4) coupled to the outlet 110 of the rotary feeder 100.

In some embodiments, the vane assembly 120 may comprise at least 4, 5, 6, 7, 8, 9, 10, 11, or 12 vanes 126. In aspects, the vanes 126 may be spaced between 30 degrees and 90 degrees apart rotationally. In some aspects, the vanes 126 are equally spaced apart about the outer surface 130 of the rotor 124. In aspects, the rotary feeder 100 may rotate the rotatable vane assembly 120 at a speed in range of from about 10 to about 24 rotations per minute (RPM). However, in some embodiments, the rotary feeder 100 may rotate the rotatable vane assembly 120 at even slower (e.g., less than 10 RPM) or faster (e.g., greater than 24 RPM) rotational speeds, for example, depending on the configuration, shape, and number of vanes 126 in the vane assembly 120, size of the cavity 106 of the housing 102 of the rotary feeder 100, the amount of agglomerates in the polymer product that is fed to the rotary feeder 100, or combinations thereof.

Referring now to FIGS. 2A to 2E, partial oblique views of various rotary feeder vane configurations are shown according to embodiments of the disclosure. The vanes of the vane assemblies 200, 210, 220, 230, and 240 in FIGS. 2A to 2E are attached to a rotor 124, which is illustrated in dashed lines, with the central axis 128 of the vane assemblies 200, 210, 220, 230, and 240 illustrated for orientation relative to the view in FIG. 1. Moreover, the number of vanes illustrated in the vane assemblies 200, 210, 220, 230, and 240 in FIGS. 2A to 2E is only the amount needed to discuss the vane configuration, and embodiments contemplate that vanes would be positioned around the entirety of the rotor 124 as is illustrated in FIG. 1. The vane assemblies 200, 210, 220, 230, and 240 can have a plurality of vanes that are identical to the vane(s) in the respective figure and that are disposed around the outer surface 130 of the rotor 124. In aspects, the vanes are equally spaced around the outer surface 130 of the rotor 124, and the spaces between the vanes receive the polymer product while the vane assemblies 200, 210, 220, 230, and 240 rotate. In aspects, any of the exposed edges illustrated in FIGS. 2A to 2E can include a blade, such as is described above. The vane assemblies 200, 210, 220, 230, and 240 rotate in the direction of arrow A; alternatively, the vane assemblies 200, 210, 220, 230, and 240 rotate in a direction that is opposite of the direction of arrow A.

The vane assembly 200 shown in FIG. 2A discloses a vane 201 having a nonlinear exposed edge 202. The nonlinear edge 202 (also referred to as a nonlinear exposed edge 202) can comprising a substantially continuous curvature. Thus, FIG. 2A is exemplary of vanes having nonlinear exposed edges that can face the inlet 108 and outlet 110 of the housing 102 as the vanes are rotated around the rotor 124.

The vane assembly 210 shown in FIG. 2B discloses that the vane 201 can have ends 203 and 204 (nonexposed side edges) connected to other vanes. In FIG. 2B, the vane 201 again has a nonlinear edge 202. A second vane 205 has an end 207 that is coupled to, connected to, or integrally formed with end 203 of the first vane 201. Second vane 205 also has a nonlinear edge 206 comprising a substantially continuous curvature. While not drawn in FIG. 2B for clarity, end 208 (also a nonexposed edge) of second vane 205 can be coupled to, connected to, or integrally formed with an end of a third vane, and end 204 of first vane 201 can be coupled to, connected to, or integrally formed with an end of a fourth vane. Opposite ends of the third and fourth vanes can similarly be coupled to, connected to, or integrally formed with the ends of other vanes. For clarity of view, the right side of the edge 206 of the second vane 205 extends further out of the page than the left side of the edge 206 of the second vane 205.

The vane assembly 220 shown in FIG. 2C discloses that vanes can have two or more portions extending at an angle relative to one another. Vane 211 has two portions: a first portion 211a and a second portion 211b. The first portion 211a has a nonlinear exposed edge 212a comprising a substantially continuous curvature, and the second portion 211b has a nonlinear exposed edge 212b comprising a substantially continuous curvature. The first portion 211a extends at an angle relative to the second portion 211b. In some embodiments, the first portion 211a and the second portion 211b may form a substantially curved V-shaped profile. Multiple vanes that are identical to vane 211 can be placed around the rotor 124, where ends 213 and 214 of the vane 211 are not coupled to, connected to, or integrally formed with other vanes. Alternatively, the end 213 and/or opposite end 214 (or nonexposed edge(s)) of the vane 211 can be coupled to, connected to, or integrally formed with an end of another vane (in similar concept to the vanes 201 and 205 in FIG. 2B). For clarity of view, the middle 215 of the vane 211 where the two portions 211a and 211b meet extends vertically on the page into the plane of the page in the view, while the left side (end 213) and right side (end 214) of the vane 211 extend out of the page. The portions 211a and 211b of the vane 211 curve around the surface 130 of the rotor 124, causing the edges 212a and 212b to be nonlinear edges.

The vane assembly 230 shown in FIG. 2D discloses that the vanes can have four or more portions extending at an angle relative to one another. Vane 231 has four portions: first portion 232a, second portion 232b connected to the first portion 232a, third portion 232c connected to the second portion 232b, and fourth portion 232d connected to the third portion 232c. The first portion 232a has a nonlinear exposed edge 233a comprising a substantially continuous curvature, the second portion 232b has a nonlinear exposed edge 233b comprising a substantially continuous curvature, third portion 232c has a nonlinear exposed edge 233c comprising a substantially continuous curvature, and fourth portion 232d has a nonlinear exposed edge 233d comprising a substantially continuous curvature. The first portion 232a extends at an angle relative to the second portion 232b, the third portion 232c extends at an angle relative to the second portion 232b, and the fourth portion 232d extends at an angle relative to the third portion 232c. The first portion 232a and third portion 232c may be substantially parallel, and the second portion 232b and fourth portion 232d may also be substantially parallel. In some embodiments, the portions 232a, 232b, 232c, and 232d may comprise a substantially curved W-shaped profile. Multiple vanes that are identical to vane 231 can be placed around the rotor 124, where ends 234 and 235 of the vane 231 are not coupled to, connected to, or integrally formed with other vanes. Alternatively, the end 234 and/or opposite end 235 (or nonexposed edge(s)) of the vane 231 can be coupled to, connected to, or integrally formed with an end of another vane (in similar concept to the vanes 201 and 205 in FIG. 2B). For clarity of view, the intermediate point 237 of the vane 231 where the first portion 232a and the second portion 232b meet and the intermediate point 238 where the third portion 232c and the fourth portion 232d meet each extends vertically on the page into the plane of the page in the view, while the left side (end 234), right side (end 235), and middle 236 (where second portion 232b and third portion 232c meet) of the vane 231 extend out of the page. The portions 232a, 232b, 232c, and 232d of the vane 231 curve around the surface 130 of the rotor 124, causing the edges 233a, 233b, 233c, and 233d to be nonlinear edges.

The vane assembly 240 shown in FIG. 2E discloses vane 241 may comprise a nonlinear exposed edge 242 comprising a substantially continuous curvature that extends helically around the central axis 128. The vane 241 extends helically around the rotor 124 so the nonlinear exposed edge 242 has a helical shape oriented around the central axis 128 of the rotor 124.

Referring now to FIGS. 3A to 3F, partial oblique views of various rotary feeder vane configurations having agglomerate pockets are shown according to embodiments of the disclosure. The vanes of vane assemblies 300, 310, 320, 330, 340, and 350 in FIGS. 3A to 3F are attached to a rotor 124, which is illustrated in dashed lines, with the central axis 128 illustrated for orientation relative to the view in FIG. 1. Moreover, the number of vanes illustrated in FIGS. 3A to 3F is only the amount needed to discuss the configuration, and embodiments contemplate that vanes would be positioned around the entirety of the rotor 124 as is illustrated in FIG. 1. The vane assemblies 300, 310, 320, 330, 340, and 350 can have a plurality of vanes that are identical to the vane(s) in the respective figure and that are disposed around the outer surface 130 of the rotor 124. In aspects, the vanes are equally spaced around the outer surface 130 of the rotor 124, and the carrier spaces 134 between the vanes receive the polymer product while the vane assemblies 300, 310, 320, 330, 340, and 350 rotate. In aspects, any of the exposed edges illustrated in FIGS. 3A to 3F can include a blade, such as is described above. The vane assemblies 300, 310, 320, 330, 340, and 350 rotate in the direction of arrow A; alternatively, the vane assemblies 300, 310, 320, 330, 340, and 350 rotate in a direction that is opposite of the direction of arrow A.

In the vane assemblies 300, 310, 320, 330, 340, and 350 of FIGS. 3A to 3F, the illustrated vanes have a pocket defined by different portions of the linear or nonlinear edges of the vane(s). The different portions of the edges of the vane, in combination with the side walls of the housing 102 and/or inner surface or wall 104 of the housing 102 form pockets or spaces that can receive polymer agglomerates and rotate them through the rotary feeder 100 from inlet 108 to outlet 110 with reduced disruption to the speed of rotation of the vane assembly and reduced disruption to flow rate of polymer particles through the rotary feeder 100 compared to a rotary feeder that does not include vanes with agglomerate pockets. In some embodiments, the pockets may span across different portions of a vane that are oriented at different angles with respect to one another. In some embodiments, the pockets may comprise the same height with respect to the distance between an exposed edge of a vane and the inner surface or wall 104 of the housing 102. Alternatively, in some embodiments, the pockets may comprise different sizes, such that the size of pocket(s) in a single vane can be the same or different and/or the size of pockets in adjacent or other vanes in a vane assembly are the same or different.

The vane assembly 300 shown in FIG. 3A discloses a vane 301 having two linear exposed edges 306a and 306b, where the second linear exposed edge 306b forms a pocket 302. The vane 301 has a first portion 304a and a second portion 304b, and the pocket 302 is formed between the linear exposed edge 306b of the second portion 304b, a side edge 303 of the first portion 304a of the vane 301, the side wall of the housing 102, and the inner surface or wall 104 of the housing 102. As such, the distance between the exposed edge 306a of the first portion 304a and the inner surface or wall 104 of the housing 102 is less than the distance between an exposed edge 306b of the second portion 304b and the inner surface or wall 104 of the housing 102. While the pocket 302 in FIG. 3A is illustrated being on the right side of the vane 301; alternative embodiments contemplate that the pocket 302 can be located similarly as illustrated in FIG. 3C, 3D, or 3E, except vane 301 has linear exposed edges 306a and 306b instead of the nonlinear exposed edges for the vanes in FIGS. 3D, 3D, and 3E.

The vane assemblies 310 and 320 shown in FIGS. 3B and 3C disclose vanes with nonlinear exposed edges and an agglomerate pockets.

The vane assembly 310 shown in FIG. 3B discloses a vane 311 having two linear exposed edges 316a and 316b, where the second linear exposed edge 316b forms a pocket 312. The vane 311 is similar to the vane 201 in FIG. 2A, except the vane 311 in FIG. 3B has the pocket 312. The vane 311 has a first portion 314a and a second portion 314b, and the pocket 312 is formed between the linear exposed edge 316b of the second portion 314b, a side edge 313 of the first portion 314a of the vane 311, the side wall of the housing 102, and the inner surface or wall 104 of the housing 102. As such, the distance between the exposed edge 316a of the first portion 314a and the inner surface or wall 104 of the housing 102 is less than the distance between an exposed edge 316b of the second portion 314b and the inner surface or wall 104 of the housing 102. While the pocket 312 in FIG. 3B is illustrated being on the right side of the vane 311; alternative embodiments contemplate that the pocket 312 can be located similarly as illustrated in FIG. 3C, 3D, or 3E. For clarity of the view, side edge 317 of the vane 311 extends vertically in the plane of the page, and side edge 318 extends outward of the page.

The vane assembly 330 shown in FIG. 3C discloses a vane 321 having two linear exposed edges 326a and 326b, where the first linear exposed edge 326a forms a pocket 322. The vane 321 is similar to the vane 201 in FIG. 2A, except the vane 321 in FIG. 3C has the pocket 322. The vane 321 has a first portion 324a and a second portion 324b, and the pocket 322 is formed between the linear exposed edge 326a of the first portion 324a, a side edge 323 of the second portion 324b of the vane 321, the side wall of the housing 102, and the inner surface or wall 104 of the housing 102. As such, the distance between the exposed edge 326b of the second portion 324b and the inner surface or wall 104 of the housing 102 is less than the distance between an exposed edge 326a of the first portion 324a and the inner surface or wall 104 of the housing 102. While the pocket 322 in FIG. 3C is illustrated being on the left side of the vane 321; alternative embodiments contemplate that the pocket 322 can be located similarly as illustrated in FIG. 3B, 3D, or 3E. For clarity of the view, side edge 327 of the vane 321 extends vertically in the plane of the page, and side edge 328 extends outward of the page.

The vane assembly 330 shown in FIG. 3D discloses a vane 331 having three linear exposed edges 336a, 336b, and 336c, where the first linear exposed edge 336a forms a first pocket 332a and the third linear exposed edge 336c forms a second pocket 332b. The vane 331 is similar to the vane 201 in FIG. 2A, except the vane 331 in FIG. 3D has pockets 332a and 332b. The vane 331 has a first portion 334a, a second portion 334b, and a third portion 334c, where the second portion 334b is between the first portion 334a and the third portion 334c. The first pocket 332a is formed between the linear exposed edge 336a of the first portion 334a, a side edge 333a of the second portion 334b of the vane 331, the side wall of the housing 102, and the inner surface or wall 104 of the housing 102. The second pocket 332b is formed between the linear exposed edge 336c of the third portion 334c, a side edge 333b of the second portion 334b of the vane 331, the side wall of the housing 102, and the inner surface or wall 104 of the housing 102. As such, the distance between the exposed edge 336b of the second portion 334b and the inner surface or wall 104 of the housing 102 is less than the distance between an exposed edge 336a of the first portion 334a and the inner surface or wall 104 of the housing 102 and less than the distance between the exposed edge 33c of the third portion 334c and the inner surface or wall 104 of the housing 102. For clarity of the view, side edge 337 of the vane 331 extends vertically in the plane of the page, and side edge 338 extends outward of the page.

The vane assembly 340 shown in FIG. 3E discloses a vane 341 having three linear exposed edges 346a, 346b, and 346c, where the second linear exposed edge 336b forms a pocket 342. The vane 341 is similar to the vane 201 in FIG. 2A, except the vane 341 in FIG. 3D has pocket 342. The vane 341 has a first portion 344a, a second portion 344b, and a third portion 344c, where the second portion 344b is between the first portion 344a and the third portion 344c. The pocket 342 is formed between the linear exposed edge 336b of the second portion 344b, a side edge 343a of the first portion 334a of the vane 341, a side edge 343b of the third portion 334c of the vane 341, and the inner surface or wall 104 of the housing 102. As such, the distance between the exposed edge 336a of the first portion 334a and the inner surface or wall 104 of the housing 102 and the distance between the exposed edge 336c of the third portion 334c and the inner surface or wall 104 of the housing 102 is less than the distance between an exposed edge 336b of the second portion 334b and the inner surface or wall 104 of the housing 102. For clarity of the view, side edge 347 of the vane 341 extends vertically in the plane of the page, and side edge 348 extends outward of the page.

The vane assembly 350 shown in FIG. 3F discloses a vane 351 having a similar configuration as that shown in FIG. 2D and comprising multiple pockets 352a, 352b, and 352c.

Referring to FIG. 4 a schematic diagram of a polymer processing system 400 is shown according to an embodiment of the disclosure. The system 400 can include one or more of a purge column or hopper 402, the rotary feeder 100, a classifier 404, an agglomerate collection device 406, a fluff hopper 408, a second rotary feeder 410, and an extruder 412. The purge column or hopper 402 has an outlet that is fluidly connected to the inlet 108 of the rotary feeder 100, the classifier 404 has an inlet that is fluidly connected to an outlet 110 of the rotary feeder 100, the agglomerate collection device 406 has an inlet that can be fluidly connected to an agglomerate outlet of the classifier 404, the fluff hopper 408 has an inlet that can be fluidly connected to a polymer fluff outlet of the classifier 404, the second rotary feeder 410 can have an inlet fluidly connected to an outlet of the fluff hopper 408, and the extruder 412 can have an inlet fluidly connected to an outlet of the second rotary feeder 410. The components of the system 400 can be connected by pipes, lines, flanges, and other equipment known in the art with the aid of this disclosure.

In operation of the system 400, polymer product may be fed into a purge column or hopper 402 into the rotary feeder 100. A purge column, also called a degasser, is a vessel that can receive polymer product therein (e.g., from a flash tank or from a transfer line that is coupled to an outlet of a polymerization reactor), and a purge gas (e.g., nitrogen) is injected into the purge column so that the gas flows through the space between the polymer particles and any agglomerates to remove residual or entrained liquid hydrocarbons from the polymer product. A hopper is a vessel that can receive polymer product therein, (e.g., from a flash tank or from a transfer line that is coupled to an outlet of a polymerization reactor at flow rates that change over time), while maintaining a constant flow rate of polymer product out of the hopper. Some of the polymer product may be embodied as agglomerated polymeric chunks; thus, the outlet of the purge column or hopper 402 can be sized so that that agglomerates can flow out of the hopper and into the rotary feeder 100.

The rotary feeder 100 receives the polymer product from the purge column or hopper 402. According to embodiments disclosed herein, the rotary feeder 100 may break (e.g., chop, divide, slice, sever, or otherwise separate) at least some of the agglomerates into smaller, workable polymeric pieces or fragments. The rotary feeder 100 may move or pass these pieces or fragments and any remaining agglomerates into a classifier 404. In additional or alternative embodiments, the rotary feeder 100 may receive at least some of the agglomerates into pockets as described herein without breaking the agglomerates into smaller pieces, and move or pass the agglomerates through the rotary feeder 100 to the classifier 404. In aspects, the polymer product that flows in the outlet 110 of the rotary feeder 100 contains polymer particles, agglomerates, pieces of broken agglomerate(s), or a combination thereof.

The classifier 404 may separate the polymer product received from the rotary feeder 100 into different size groups. For example, any remaining agglomerates can be separated from polymer fluff, any pieces of the agglomerates can be separated from the polymer fluff, both agglomerates and pieces of broken agglomerates can be separated from the polymer fluff, or agglomerates are separated from the polymer fluff and the pieces of the broken agglomerates.

The classifier 404 can be embodied as a device having trays or screens for separating agglomerates from polymer fluff by size, for example trays having holes formed therein or screens have a mesh size suitable for allowing polymer fluff to pass through the screen while holding back agglomerates. In other embodiments the trays or screens can also hold back pieces of agglomerates to separate the pieces from the polymer fluff; alternatively, the trays or screens can allow the pieces of agglomerates to pass through with the polymer fluff. Agglomerates, pieces of agglomerates, or both, can be transferred from the retention side of the trays or screens of the classifier 404 to an agglomerate collection device 406, where the agglomerates and/or pieces may then either be automatically or manually reintroduced into the hopper 402 or stored for other processing or disposal.

The polymer fluff, and in some case the polymer fluff with pieces of broken agglomerates, may flow from the classifier 404 into a fluff hopper 408. The fluff hopper 408 is a vessel that contains a volume of polymer that is introduced into a second rotary feeder 410. The second rotary feeder 410 can be a traditional rotary feeder or can be embodied as a rotary feeder 100 disclosed herein.

The second rotary feeder 410 can introduce the polymer fluff to the extruder 412. The extruder 412, sometimes referred to as a pelletizer, can convey, heat, melt, and cut the extruder feed, and the molten polymer mixture can be extruded through a pelletizing die under pressure to form the polymer extrudate. The polymer extrudate can then be cooled (e.g., in air or water) at or near the discharge region of the extruder. The polymer extrudate may then be transported to a product load-out area for further use such as storing, blending with other pellets, and/or loading into railcars, trucks, bags, supersacks, or other containers for distribution to customer(s). In aspects, the extruder is a single screw or twin screw extruder as is known in the art with the aid of this disclosure.

Embodiments of a rotary feeder 100 or process of using a rotary feeder 100 disclosed herein may include one or more of the following embodiments:
Aspect 1. A rotary feeder for a polymer product, comprising: a housing having an inner wall that defines a cavity, wherein the housing has an inlet fluidly connected to the cavity and an outlet fluidly connected to the cavity; a shaft disposed in the housing along a central axis of the cavity; and a rotor coupled to the shaft, wherein the shaft and the rotor rotate within cavity of the housing to move the polymer product from the inlet to the outlet, wherein the rotor comprises a plurality of vanes arranged to: i) break, with at least one nonlinear edge of the plurality of vanes, an agglomerate of the polymer product into pieces that are smaller than the agglomerate, and move the pieces from the inlet to the outlet while the rotor rotates in the housing, ii) receive the agglomerate in an agglomerate pocket of the plurality of vanes, and move the agglomerate in the agglomerate pocket from the inlet to the outlet while the rotor rotates within the housing, or iii) break, with at least one nonlinear edge of the plurality of vanes, an agglomerate of the polymer product into pieces that are smaller than the agglomerate, receive the pieces in an agglomerate pocket of the plurality of vanes, and move the pieces in the agglomerate pocket from the inlet to the outlet while the rotor rotates within the housing.
Aspect 2. The rotary feeder of any of the preceding Aspects, wherein each of the plurality of vanes has one nonlinear edge that has a continuous curvature.
Aspect 3. The rotary feeder of any of the preceding Aspects, wherein each of the plurality of vanes has a side edge, wherein the side edges of two adjacent vanes couple to one another.
Aspect 4. The rotary feeder of any of the preceding Aspects, wherein each of the plurality of vanes has a first portion and a second portion, wherein the first portion extends at an angle relative to the second portion, wherein the first portion has a first nonlinear edge and the second portion has a second nonlinear edge.
Aspect 5. The rotary feeder of any of the preceding Aspects, wherein the at least one nonlinear edge has a helical shape oriented around a central axis of the rotor.
Aspect 6. The rotary feeder of any of the preceding Aspects, wherein one of the plurality of vanes comprises a first portion and a second portion, wherein a first distance between a first edge of the first portion and the inner wall of the housing is less than a second distance between a second edge of the second portion and the inner wall of the housing so that the agglomerate pocket is formed between the inner wall of the housing and the second edge.
Aspect 7. The rotary feeder of any of the preceding Aspects, wherein the one of the plurality of vanes further comprises a third portion, wherein the first distance between the first edge of the first portion and the inner wall of the housing is less than a third distance between a third edge of the third portion and the inner wall of the housing so that a second agglomerate pocket is formed between the inner wall of the housing and the third edge.
Aspect 8. A process, comprising: rotating a rotor in a housing of a polymer rotary feeder, wherein the rotor comprises a plurality of vanes having an agglomerate pocket and carrier spaces; receiving an agglomerate of a polymer product into the agglomerate pocket; receiving pieces of the polymer product that are smaller than the agglomerate into the carrier spaces; and moving the agglomerate in the agglomerate pocket and the pieces in the carrier spaces from an inlet of the housing to an outlet of the housing.
Aspect 9. The process of any of the preceding Aspects, wherein one of the plurality of vanes comprises a first portion and a second portion, wherein a first distance between a first edge of the first portion and an inner wall of housing is less than a second distance between a second edge of the second portion and the inner wall of the housing so that the agglomerate pocket is formed between the inner wall of the housing and the second edge.
Aspect 10. The process of any of the preceding Aspects, wherein the one of the plurality of vanes further comprises a third portion, wherein the first distance between the first edge of the first portion and the inner wall of the housing is less than a third distance between a third edge of the third portion and the inner wall of the housing so that a second agglomerate pocket is formed between the inner wall of the housing and the third edge.
Aspect 11. The process of any of the preceding Aspects, further comprising: recovering the polymer product from a polymerization system; and moving the polymer product to the inlet of the housing of the polymer rotary feeder.
Aspect 12A. The process of any of the preceding Aspects, further comprising: flowing the agglomerate and the polymer fluff from the outlet of the polymer rotary feeder to a classifier; and separating, by the classifier, the polymer fluff from the agglomerate.
Aspects 12B. The process of any of the preceding Aspects, further comprising: flowing the polymer fluff from the classifier to a hopper; and introducing the polymer fluff from the hopper to an extruder via a second rotary feeder.
Aspect 13. The process of any of the preceding Aspects, wherein the agglomerate has a size that would not move through an otherwise similar rotary feeder that has the carrier spaces but not the agglomerate pocket.
Aspect 14. The process of any of the preceding Aspects, further comprising: polymerizing an olefin in a polymerization reactor (e.g., loop slurry reactor, gas phase reactor, autoclave reactor, or combinations thereof) to form a polyolefin; recovering a reaction effluent from the polymerization reactor; and recovering the polymer product from the reaction effluent.
Aspect 15. A process, comprising: rotating a rotor in a housing of a polymer rotary feeder, wherein the rotor comprises a plurality of vanes having at least one nonlinear edge; breaking an agglomerate of a polymer product into pieces that are smaller than the agglomerate with the at least one nonlinear edge; and moving the pieces in the plurality of vanes from an inlet of the housing to an outlet of the housing.
Aspect 16. The process of any of the preceding Aspects, wherein each of the plurality of vanes has one nonlinear edge that has a continuous curvature.
Aspect 17. The process of any of the preceding Aspects, wherein each of the plurality of vanes has a side edge, wherein the side edges of two adjacent vanes couple to one another.
Aspect 18. The process of any of the preceding Aspects, wherein each of the plurality of vanes has a first portion and a second portion, wherein the first portion extends at an angle relative to the second portion, wherein the first portion has a first nonlinear edge and the second portion has a second nonlinear edge.
Aspect 19. The process of any of the preceding Aspects, wherein the at least one nonlinear edge has a helical shape oriented around a central axis of the rotor.
Aspect 20. The process of any of the preceding Aspects, further comprising: recovering the agglomerate and the pieces of the polymer product from a polymerization system; and moving the agglomerate and the pieces of the polymer product to the inlet of the housing of the polymer rotary feeder.
Aspect 21A. The process of any of the preceding Aspects, further comprising: flowing the agglomerate and the pieces of the polymer product from the outlet of the polymer rotary feeder to a classifier; and separating polymer fluff contained in the polymer product from the agglomerate and the pieces of the polymer product.
Aspects 21B. The process of any of the preceding Aspects, further comprising: flowing the polymer fluff from the classifier to a hopper; and introducing the polymer fluff from the hopper to an extruder via a second rotary feeder.
Aspect 22. The process of any of the preceding Aspects, further comprising: polymerizing an olefin in a polymerization reactor (e.g., loop slurry reactor, gas phase reactor, autoclave reactor, or combinations thereof) to form a polyolefin; recovering a reaction effluent from the polymerization reactor; and recovering the polymer product from the reaction effluent.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A rotary feeder for a polymer product, comprising:
a housing having an inner wall that defines a cavity, wherein the housing has an inlet fluidly connected to the cavity and an outlet fluidly connected to the cavity;
a shaft disposed in the housing along a central axis of the cavity; and
a rotor coupled to the shaft, wherein the shaft and the rotor rotate within cavity of the housing to move the polymer product from the inlet to the outlet,
wherein the rotor comprises a plurality of vanes arranged to:
i) break, with at least one nonlinear edge of the plurality of vanes, an agglomerate of the polymer product into pieces that are smaller than the agglomerate, and move the pieces from the inlet to the outlet while the rotor rotates in the housing,
ii) receive the agglomerate in an agglomerate pocket of the plurality of vanes, and move the agglomerate in the agglomerate pocket from the inlet to the outlet while the rotor rotates within the housing, or
iii) break, with at least one nonlinear edge of the plurality of vanes, an agglomerate of the polymer product into pieces that are smaller than the agglomerate, receive the pieces in an agglomerate pocket of the plurality of vanes, and move the pieces in the agglomerate pocket from the inlet to the outlet while the rotor rotates within the housing.

2. The rotary feeder of claim 1, wherein each of the plurality of vanes has one nonlinear edge that has a continuous curvature.

3. The rotary feeder of claim 2, wherein each of the plurality of vanes has a side edge, wherein the side edges of two adjacent vanes couple to one another.

4. The rotary feeder of claim 1, wherein each of the plurality of vanes has a first portion and a second portion, wherein the first portion extends at an angle relative to the second portion, wherein the first portion has a first nonlinear edge and the second portion has a second nonlinear edge.

5. The rotary feeder of claim 1, wherein the at least one nonlinear edge has a helical shape oriented around a central axis of the rotor.

6. The rotary feeder of claim 1, wherein one of the plurality of vanes comprises a first portion and a second portion, wherein a first distance between a first edge of the first portion and the inner wall of the housing is less than a second distance between a second edge of the second portion and the inner wall of the housing so that the agglomerate pocket is formed between the inner wall of the housing and the second edge.

7. The rotary feeder of claim 6, wherein the one of the plurality of vanes further comprises a third portion, wherein the first distance between the first edge of the first portion and the inner wall of the housing is less than a third distance between a third edge of the third portion and the inner wall of the housing so that a second agglomerate pocket is formed between the inner wall of the housing and the third edge.

8. A process, comprising:
rotating a rotor in a housing of a polymer rotary feeder, wherein the rotor comprises a plurality of vanes having an agglomerate pocket and carrier spaces;
receiving an agglomerate of a polymer product into the agglomerate pocket;
receiving polymer fluff into the carrier spaces; and
moving the agglomerate in the agglomerate pocket and the polymer fluff in the carrier spaces from an inlet of the housing to an outlet of the housing.

9. The process of claim 8, wherein one of the plurality of vanes comprises a first portion and a second portion, wherein a first distance between a first edge of the first portion and an inner wall of housing is less than a second distance between a second edge of the second portion and the inner wall of the housing so that the agglomerate pocket is formed between the inner wall of the housing and the second edge.

10. The process of claim 9, wherein the one of the plurality of vanes further comprises a third portion, wherein the first distance between the first edge of the first portion and the inner wall of the housing is less than a third distance between a third edge of the third portion and the inner wall of the housing so that a second agglomerate pocket is formed between the inner wall of the housing and the third edge.

11. The process of claim 8, further comprising:
recovering the polymer product from a polymerization system; and
moving the polymer product to the inlet of the housing of the polymer rotary feeder.

12. The process of claim 8, further comprising:
flowing the agglomerate and the polymer fluff from the outlet of the polymer rotary feeder to a classifier; and
separating, by the classifier, the polymer fluff from the agglomerate.

13. The process of claim 12, wherein the agglomerate has a size that would not move through an otherwise similar rotary feeder that has the carrier spaces but not the agglomerate pocket.

14. A process, comprising:
rotating a rotor in a housing of a polymer rotary feeder, wherein the rotor comprises a plurality of vanes having at least one nonlinear edge;
breaking an agglomerate of a polymer product into pieces that are smaller than the agglomerate with the at least one nonlinear edge; and
moving the pieces in the plurality of vanes from an inlet of the housing to an outlet of the housing.

15. The process of claim 14, wherein each of the plurality of vanes has one nonlinear edge that has a continuous curvature.

16. The process of claim 15, wherein each of the plurality of vanes has a side edge, wherein the side edges of two adjacent vanes couple to one another.

17. The process of claim 14, wherein each of the plurality of vanes has a first portion and a second portion, wherein the first portion extends at an angle relative to the second portion, wherein the first portion has a first nonlinear edge and the second portion has a second nonlinear edge.

18. The process of claim 14, wherein the at least one nonlinear edge has a helical shape oriented around a central axis of the rotor.

19. The process of claim 14, further comprising:
recovering the polymer product from a polymerization system; and
moving the polymer product to the inlet of the housing of the polymer rotary feeder.

20. The process of claim 14, further comprising:
flowing the agglomerate and the pieces of the polymer product from the outlet of the polymer rotary feeder to a classifier; and
separating polymer fluff contained in the polymer product from the agglomerate and the pieces of the polymer product.
